(19) United States
(12) Patent Application Publication
(10) Pub. No.: US 2003/0098865 A1
(43) Pub. Date: May 29, 2003

(54) Customizable animated instruction

(76) Inventors: Andrew P. Alegria, Nampa, ID (US); Brett A. Smith, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/994,637

(22) Filed: Nov. 28, 2001

(51) Int. Cl. G06T 13/00; G06T 15/70

(52) U.S. Cl. 345/473

(57) ABSTRACT

A method and a system for generating an animated instruction based on a procedure. In the method, an instruction for performing a procedure is determined based on environmental data and an animated instruction performing the procedure is automatically generated in response to the instruction. In the system, based on environmental data, an instruction for performing a procedure is generated by an instruction generating module and in response to the instruction, an animated instruction for performing the procedure is automatically generate by an animation generator module configured to communicate with the instruction generating module.

### FIELD OF THE INVENTION

This invention relates generally to support of computers, electrical and mechanical systems, and more particularly, although not exclusively, to initialization, configuration and operation of computers, electrical and mechanical systems.

### BACKGROUND OF THE INVENTION

Typically, a product sold today contains an instruction manual. Generally, the more complicated and/or the more features the product has, the more information is included in the instruction manual. This can be problematic given the complexity of many of today's home and office electronic devices (e.g., printers, copiers, computers, etc.).

Furthermore, a user may utilize only a relative small portion of the instruction manual. For example, in an instruction manual written in three languages, only one third of the manual may even be readable by the user. In a second example, an instruction manual for a network compatible printer may include several sections on network installation, configuration, etc., however, if the printer is not installed in a network environment, those sections may simply get in the way and make it harder for the user to find pertinent information. To address this problem, electronic instruction manuals generally include extensive search capabilities and may be configured to include only the information requested.

While electronic or on-line instruction manuals have made it somewhat easier to find specified information, a user may not know the name of a specific operation or mechanical part. In this regard, illustrations have traditionally been employed to acquaint the user with the various parts of the device. Although somewhat helpful, conventional illustrations are generally static and may only show a couple of views of the device. Thus, for a device such as a computer, having a multitude of possible accessories (e.g., printer, scanner, speakers, camera, etc.) that may be attached in a nearly infinite number of combinations, conventional illustrations rarely depict the user's specific environment.

### SUMMARY OF THE INVENTION

In one respect, the invention pertains to a method of generating customized animated instructions. In the method, an instruction for performing a procedure is determined based on environmental data and an animated instruction performing the procedure is automatically generated in response to the instruction.

In another respect, the invention pertains to a computer readable medium on which is embedded computer software. The software includes executable code for performing a method of generating customized animated instructions. In the method, an instruction for performing a procedure is determined based on environmental data and an animated instruction performing the procedure is automatically generated in response to the instruction.

In yet another respect, the invention pertains to a system for generating customized animated instructions. In the system, based on environmental data, an instruction for performing a procedure is generated by an instruction generating module and in response to the instruction, an animated instruction for performing the procedure is automatically generate by an animation generator module configured to communicate with the instruction generating module.

### BRIEF DESCRIPTION OF THE DRAWINGS

FIG. 1 is a block diagram illustrating an exemplary computing environment in which an embodiment of the invention may be practiced;

FIG. 2 is a system architecture diagram of an exemplary application according to an embodiment of the invention; and

FIG. 3 is a flow diagram of a method, according to an embodiment of the invention.

### DETAILED DESCRIPTION OF A PREFERRED EMBODIMENT

For simplicity and illustrative purposes, the principles of the invention are described by referring mainly to an exemplary embodiment thereof, particularly with references to a system to visually facilitate installation and configuration of a network printer. However, one of ordinary skill in the art would readily recognize that the same principles are equally applicable to, and may be implemented in, a system capable of auditory and visual facilitation of initialization, configuration and operation of computers, electrical and mechanical systems, and that any such variations are within the scope of the invention. While in the following description numerous specific details are set forth in order to provide a thorough understanding of an embodiment of the invention, in other instances, well known methods and structures have not been described in detail so as not to obscure the invention. Furthermore, the terms “connected” and its variants, as used herein, mean connected directly or indirectly through an intermediary element.

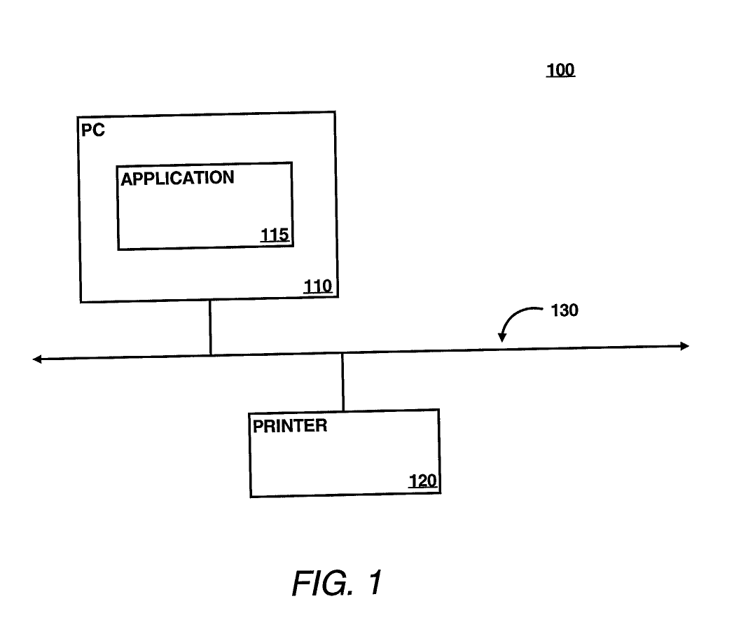

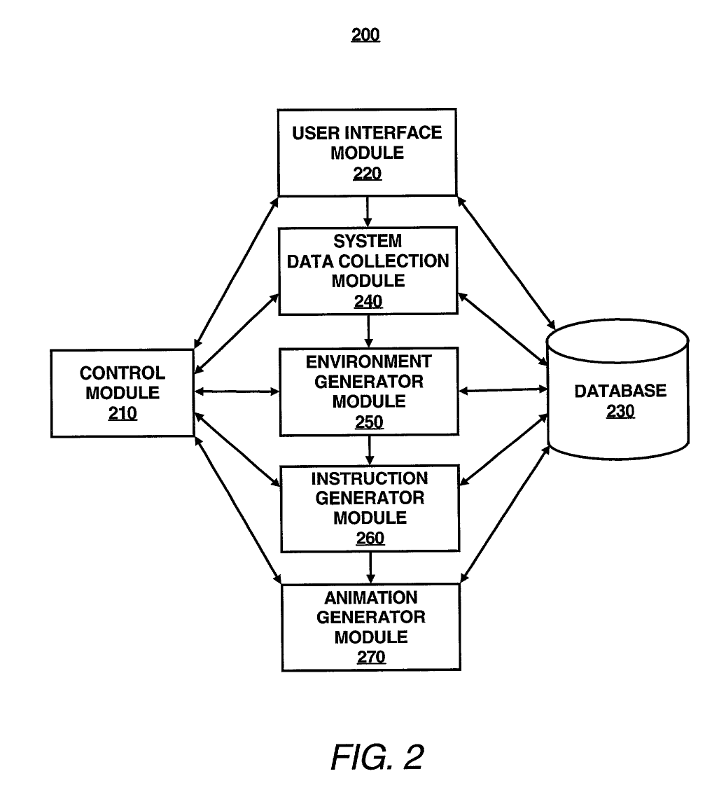

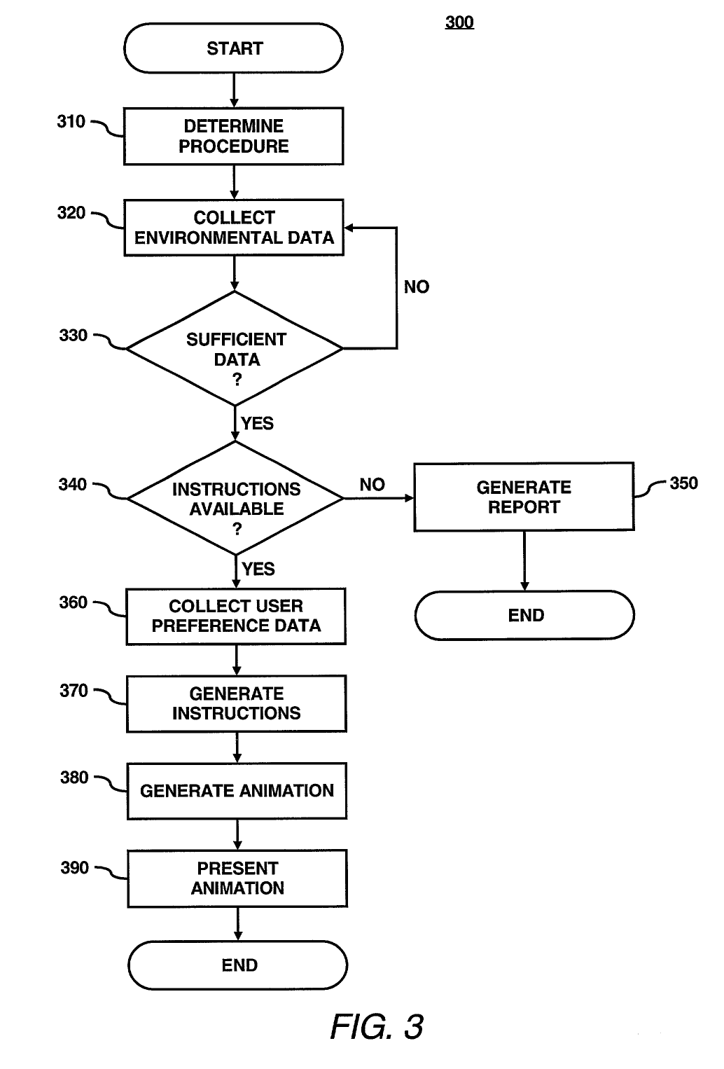

In general, various embodiments of the invention pertain to a customizable animated instruction generator. In a relatively simple form, an embodiment of the invention may pertain to an isolated process or procedure. For example, unpacking a printer, illustrating locations of important features of the printer (e.g., product serial number, port connection, on/off switch, etc.) and illustrating other important items packed with the printer (e.g., connector cables, power cord, product warranty card, etc.). In a relatively complex form, an embodiment of the invention may pertain a procedure involving a system, the system including a plurality of interconnected devices. For example, installing and/or configuring a network printer. In this regard, an existing system or network similar to the network illustrated in FIG. 1 may represent an environment in which a device, such as the network printer, is to be installed and/or configured. An application, such as the application depicted in FIG. 2 may facilitate the installation and/or configuration by providing a user an animated instruction for performing the procedure that is based on the user's specific situation. To digress in this regard, environmental data may be generally defined as data associated with the user's specific situation and more particularly defined as data associated component(s) within the environment. To continue, the application may perform a method such as the method depicted in FIG. 3.

FIG. 1 is a block diagram illustrating an exemplary environment 100 according to an embodiment of the invention. As shown in FIG. 1, the environment 100 may include a personal computer (“PC”) 110, a printer 120 and a network 130. Although not illustrated, the environment 100 may also include any reasonable number of additional components, e.g., clients, servers, printer spoolers, repeaters, hubs, bridges, routers, etc. The network 130 is preferably configured to provide a communication path for one or more network devices to communicate with one or more other network devices. The network 130 may be configured to operate over the Internet, public switched telephone network, a local area network or the like. Furthermore, it is within the scope of the invention that some or all of the functionality of the environment 100 may be subsumed within a single device. Accordingly, the environment 100 described is for illustrative purposes only and thus not meant to limit the invention in any respect.

The PC 110 may be configured to provide the capability to at least operate an application 115. However, as is well known to those skilled in the art, the application 115 may be operated in various forms (e.g., client/server, stand alone, etc.) and it is to be understood that these various forms are within the scope of the invention. Additionally, the PC 110 may be configured to access data stored to a storage medium such as a compact disk (“CD”), a digital video disk (“DVD”) and the like.

In one form, the application 115 may be configured to provide a user with the capacity to access the Web, display a selected Web page and initiate animated instructions associated with the selected Web page. In another form, the application 115 may be configured to provide a user with the capability to access data on a storage medium. The application 115 may further be configured with a user interface (“UI”). The UI may be configured to display information and questions to the user and provide the user with the capacity to select various options and/or answer questions. Furthermore, the term application is not meant to be a limitation, but rather, describes any computer software or firmware capable of displaying animated instructions to the user.

FIG. 2 is a system architecture diagram of an exemplary application 200 according to an embodiment of the invention. The following description of FIG. 2 will be made with particular reference to the environment 100 described in FIG. 1. Accordingly, as depicted in FIG. 2, the application 200 including a control module 210. The control module 210 may, for example, in response to initiation, initiate a user interface module 220 and/or a system data collection module 240. In operation, the application 200 may be initiated from a Web browser e.g., NETSCAPE NAVIGATOR, MICROSOFT INTERNET EXPLORER, etc. (not shown) or, preferably, from a storage medium such as a CD, a DVD and the like. Although FIG. 2 depicts the control module 210, it is well known to those having ordinary skill in the art that the control module 210 is optional and that the control functions of the control module 210 may be subsumed within the remaining modules without departing from the scope of the invention.

The user interface module 220 may comprise a user interface and associated logic to query the user regarding personal preference information and/or information associated with the environment 100. The information gathered may be stored to the database 230 and/or passed to the various other modules of the application 200.

The database 230 may be configured to store various data associated with the environment 100. For example, the database 230 may be configured to store a schematic illustration of each component of the environment 100. In one form, the database 230 may include data associated with a relatively large number of possible components of the environment 100. In another form, data associated with components determined to be present in the environment 100 may be stored to the database 230 in response to determining the components. Additionally, the database 230 may be configured to store data associated with the user preferences.

The system data collection module 240 may be configured to perform a variety of functions designed to determine data associated with the environment 100. For example, the system data collection module 240 may be configured to access one or more system files of the PC 110 and gather information from the system file(s). In this respect, the data collection module in particular or, more generally, the application 200 may further be configured to write information to the system file(s). The system data collection module 240 may further be configured to forward the system data to the database 230 and/or an environment generator module 250.

The environment generator module 250 may be configured to perform the functions requested by the control module 210. Alternatively, in response to receiving the system data, the environment generator module 250 may be initiated. In this respect, the environment generator module 250 may be configured to reference the user preference data, the data associated with the environment 100 and/or the database 230. The environment generator module 250 may further be configured with a parser to generate a table of components. The table of components may include information associated with the manner of connections between the various components, the physical dimensions of the various components, etc. The environment generator module 250 may further be configured to forward the table of components to a instruction generator module 260.

The instruction generator module 260 may be configured to perform the functions requested by the control module 210. Alternatively, in response to receiving the table of components, the instruction generator module 260 may be initiated. In this respect, the instruction generator module 260 may be configured to reference the table of components, the database 230, and user preferences to generate a customized set of instructions for the user. In the event the environment generator module 250 is not able to generate a sufficiently detailed environment or the instruction generator module 260 is not able to generate a customized set of instructions, a message including any known information may be forwarded to the user and/or technical support staff. The instruction generator module 260 may further be configured to forward the customized set of instructions to the database 230 and/or an animation generator module 270.

The animation generator module 270 may be configured to perform the functions requested by the control module 210. Alternatively, in response to receiving the customized set of instructions, the animation generator module 270 may be initiated. In one form, the animation generator 270 may be configured to reference the customized set of instructions, the table of components, the database 230, and/or user preferences to generate an animated instructions.

In one form, the animated set of instruction may be stored in a standard video format (e.g., moving picture expert group “MPEG” format, etc.) on the PC 110, on a storage device (not shown) such as disk drive, a recordable CD or DVD for example. In this form, the animated instructions may be accessed and displayed by an existing video display utility. In another form, in addition to generating the animated instructions, the application 200 may be configured to present the animated instructions to the user. In this respect, the user interface module 220 may comprise associated logic to present the animated instructions to the user as required. For example, the user interface module 220 may include user selectable controls to play, pause, stop, zoom, pan, repeat a segment, etc. The animation generator module 270 and/or the user interface module 220 may be further configured to store the animated instructions to the database 230.

FIG. 3 is a flow diagram of a method 300, according to an embodiment of the invention. Although not depicted in FIG. 3, prior to initiating the method 300, the database 230, as shown in FIG. 2, may be generated. The data stored within the database 230 may include data associated with schematic illustrations, user preferences, the environment 100, the table of components, the set of instructions, and/or the animated instructions.

The method 300 may be initiated in response to an action by the user. For example, the user may insert into the PC 110 a CD comprising the application 200. In a second example, the user may select an icon to initiate the application 200. In one form, at step 310 a procedure for which animated instruction are to be generated may be determined or received. For example, if it is determined that the application 200 has not previously run on the PC 110 and/or a print driver for the printer 120 have not been installed, the application 200 may determine that animated instructions for an installation procedure are to be generated. In a second example, the user may select a procedure for which an animated instruction is to be generated. Following step 310, the method 300 may proceed to step 320.

At step 320, information associated with the environment 100 may be gathered by accessing the system file(s) of the PC 110 and/or other components of the environment 100. Particular types of information gathered may include data associated with interrupt requests (“IRQs”), peripheral devices, system settings, manufacturer, model numbers, etc. Additionally or alternatively, information associated with the environment 100 may be gathered from the user. For example, the user interface module 220 may query the user regarding the manufacturer and model of various components of the environment 100. Following step 320, the method 300 may proceed to step 330.

At step 330, the information associated with the environment 100 may be evaluated. If it is determined the information is insufficient, the method may return to step 320. For example, if the system data collection module 240 gathers an insufficient amount of information, the method 300 may return to step 320 and the user interface module 220 may query the user. If it is determined the information is sufficient, the method may proceed to step 340.

At step 340, the available instructions for the procedure within the environment 100 may be evaluated. If it is determined that instructions for the procedure within the environment 100 are not available, the method 300 may proceed to step 350. For example, if the procedure is an installation of the printer 120 but the PC 110 utilizes an unsupported operating system, instructions may not be available. If it is determined that instructions for the procedure within the environment 100 are available, the method 300 may proceed to step 360.

At step 350, a variety of procedures may be performed. In one form, a report or a message may be generated and forwarded to the user and/or technical support staff. In this manner, a relatively accurate assessment of the situation may be determined regardless of the user's technical expertise, as opposed to the typically poor assessment of the situation given by a subset of non-technical users. Although not illustrated, in another form, the application 200 may reference a relatively larger database via the Internet and determine if instructions are available within the relatively larger database. If instructions are available, the application 200 may access the instructions and proceed to step 360.

At step 360, user preference data may be collected and/or referenced. For example, the user may prefer relatively more or less detailed instruction. Additionally, the user may prefer a male or female voice and/or instructor in the animated instruction. In one form, the user preference(s) may be collected by the user interface module 220. However, in an other form, the database 230 may be referenced to determine the user preference(s). Furthermore, it is obvious that a combination of referencing the database 230 and querying the user may be performed at step 360. In yet another form, user preference data may not be collected or referenced and the method 300 may proceed to step 370. In this respect, the user preference data may be optional. Following step 360, the method 300 may proceed to step 370.

At step 370, a set of instructions may be generated. For example, in response to the procedure within the environment 100, the database 230 may be referenced to determine at least one instruction (e.g., make certain computer is off, plug female end of RS-232 cable into port 1, etc.). A decision tree based on a relative priority and/or relative chronological order of completion for each instruction may be referenced to determine a relative order for each instruction and thus generate the set of instructions. Following step 370, the method 300 may proceed to step 380.

At step 380, an animated instructions may be generated. In a manner similar to generating known animation, a background such as an office environment or private house may be rendered (i.e., animated) depending on the user's preference. The physical characteristics of components of the environment 100 may be determined and utilized to render the components. In one form, the database 230 may be referenced to determine the physical characteristics of the components. In another form, a relatively larger database may be referenced via the Internet, for example, to determine the physical characteristics of the components. An instructor may be rendered performing the procedure in response to the set of instructions generated at step 370. Additionally, the instructor may describe the procedure verbally. In other forms, a narrator may describe the procedure verbally and/or text of the instructions may be displayed. In yet another form, verbal and text instructions may not be generated. Furthermore, it is within the scope of the invention that the instructor is not rendered and the components of the environment 100 are depicted moving without the aid of the instructor. Following step 380, the method 300 may proceed to step 390.

At step 390, the animated instructions may be presented to the user. In a preferred form, the user interface module 220 may be configured with a plurality of controls configured to provide the user with the capability to control the presentation. In this regard, the presentation of the animated instructions may be similar to a video presentation. In response to commands by the user, the presentation may play forward, reverse, pause, etc. Additionally, controls to zoom, pan and the like may be included. In another form, the animated instructions may be saved to the database 230 or various other memory (not shown). Furthermore, the animated instructions may be generated in MPEG format and forwarded to a conventional MPEG player. Following step 390, the method 300 may end or idle and await further user commands.

The method 300 may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through the Internet or other networks. Concrete examples of the foregoing include distribution of the program(s) on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method comprising:
determining an instruction for performing a procedure based on environmental data; and
automatically generating an animated instruction for performing the procedure in response to the instruction.

2. The method according to claim 1, further comprising:
determining the procedure.

3. The method according to claim 1, further comprising:
collecting the environmental data, wherein the environmental data is referenced to generate the animated instruction.

4. The method according to claim 3, wherein the environmental data is collected from a system file.

5. The method according to claim 3, wherein the environmental data is collected from a user.

6. The method according to claim 1, further comprising:
collecting user preference data, wherein the user preference data is referenced to generate the animated instruction.

7. The method according to claim 1, further comprising:
presenting the animated instruction.

8. A computer readable medium on which is embedded computer software, the software comprising executable code for performing a method comprising:
determining an instruction for performing a procedure based on environmental data; and
automatically generating an animated instruction for performing the procedure in response to the instruction.

9. The computer readable medium according to claim 8, further comprising:
determining the procedure.

10. The computer readable medium according to claim 8, further comprising:
collecting the environmental data, wherein the environmental data is referenced to generate the animated instruction.

11. The computer readable medium according to claim 10, wherein the environmental data is collected from a system file.

12. The computer readable medium according to claim 10, wherein the environmental data is collected from a user.

13. The computer readable medium according to claim 8, further comprising:
collecting user preference data, wherein the user preference data is referenced to generate the animated instruction.

14. The computer readable medium according to claim 8, further comprising:
presenting the animated instruction.

15. A system comprising:
an instruction generating module configured to generate an instruction for performing a procedure based on environmental data; and
an animation generator module configured to communicate with the instruction generating module and automatically generate an animated instruction for performing the procedure in response to the instruction.

16. The system according to claim 15, further comprising:
an environment generator module configured to communicate with the instruction generating module and to generate a table of components based on the environmental data, the table of components being utilized by the instruction generating module to generate the instruction.

17. The system according to claim 16, further comprising:
a system data collection module configured to communicate with the environment generating module and to collect the environmental data, the environmental data being utilized to generate the table of components.

18. The system according to claim 15, further comprising:
a user interface module configured to perform at least one of:
query a user regarding user preference data;
query the user regarding environmental data;
query the user regarding the procedure; and
provide the user with the capability to control a presentation of the animated instruction.

19. The system according to claim 15, further comprising:
a database configured to store data associated with at least one of:
a user preference;
an environment;
the procedure; and
the animated instruction.

20. The system according to claim 17, wherein the system data collector module is further configured to write content to a system file.
